(19) United States
(12) Patent Application Publication
(10) Pub. No.: US 2015/0062339 A1
(43) Pub. Date: Mar. 5, 2015

(54) UNMANNED AIRCRAFT SYSTEM FOR VIDEO AND DATA COMMUNICATIONS

(71) Applicant: Brian Ostrom, Huntington Beach, CA (US)

(72) Inventor: Brian Ostrom, Huntington Beach, CA (US)

(21) Appl. No.: 14/473,794

(22) Filed: Aug. 29, 2014

Related U.S. Application Data
(60) Provisional application No. 61/871,354, filed on Aug. 29, 2013.

(51) Int. Cl. H04N 5/28; H04N 21/2187; H04N 21/4223; H04N 21/218; H04N 7/18; H04B 7/26

(52) U.S. Cl. CPC H04N 5/28; H04N 7/181; H04B 7/26; H04N 21/4223; H04N 21/21805; H04N 21/2187
USPC 348/144

(57) ABSTRACT

Embodiments of an unmanned aircraft system including one or more unmanned aerial vehicles for establishing a video and communication link at a sporting event conducted over long distances are described.

### CROSS REFERENCE TO RELATED APPLICATIONS

This application claims benefit to U.S. provisional application Ser. No. 61/871,354 filed on Aug. 29, 2013, and is herein incorporated by reference in its entirety.

### FIELD

This document relates to unmanned aircraft systems, and in particular to unmanned aircraft systems for video and data communications.

### BACKGROUND

Many sporting events take place over a broad geographical area. For example, boat races may use an off-shore water raceway that covers long distances. Similarly, off-road races, such as the Baja 1000, involve multiple vehicles racing over an extended off-road course that covers relatively long distances in comparison to other racing events, such as NASCAR races, which are run on a relatively short enclosed track. Because of the hundreds of miles covered by these races, it can be difficult and expensive from a video production perspective to effectively transmit and produce various video, audio and data communications transmitted from multiple sources, such as racing vehicles, to a remote mobile production vehicle.

In addition, the popularity of smart devices has spawned a growing need for mobile applications that provide fans with various video, audio and data feeds related to certain aspects of the race. However, many of these mobile applications have limited utility and do not provide a real time experience of the race as it occurs.

### BRIEF DESCRIPTION OF THE DRAWINGS

FIG. 1 is an illustration showing the various aspects of an unmanned aircraft system;

FIG. 2 is a relational diagram showing the sensor fusion module of the unmanned aircraft system;

FIG. 3 is a simplified illustration of the unmanned aircraft system in which a plurality of unmanned aerial vehicles transmit data from an off-road race vehicle, off-shore race boat, bicyclist, rally race car, skier, tri-athlete, golfer (any non-stadium direct link broadcast sporting event) to another unmanned aerial vehicle within the unmanned aircraft system to a production vehicle for broadcast;

FIG. 4 is a relational diagram showing the various functionalities of the mobile application used with the unmanned aircraft system; and

FIG. 5 is a relational diagram showing the various functionalities of the smart device used with the unmanned aircraft system.

Corresponding reference characters indicate corresponding elements among the view of the drawings. The headings used in the figures do not limit the scope of the claims.

### DESCRIPTION

Various embodiments of an unmanned aircraft system is described herein for providing a multicast distribution network that uses one or more unmanned aerial vehicles for providing onboard as well as aerial coverage of an event, such as an off-road racing event, that covers a wide geographical area. The unmanned aerial vehicles are in operative communication with a production vehicle for processing the various video, audio and data inputs transmitted by each unmanned aerial vehicle. In addition, the unmanned aircraft system includes a mobile application in operative communication with the multicast distribution network for television broadcast and/or providing a smart device or computer apparatus with video, audio and data related to the event.

As noted above, the UAS may be used to provide video, audio and data communications for a sporting event that covers a wide geographical area, such as an off-road racecourse, a cross country racecourse, a long distance racecourse with stages, an endurance race area, a yacht racecourse, a powerboat raceway, a skiing racecourse, or a golf course. In one embodiment, the UAS may include one or more unmanned aerial vehicles (UAVs) that fly over the sporting event for establishing a communications link with a mobile production vehicle that collects the video, audio and data communications from each UAV, processes the video, audio and data communications, and then transmits the processed communications to one or more sources, such as other vehicles participating in the sporting event as well as mobile smart devices used by fans attending the sporting event either on-site or remotely. As used herein, the term “unmanned aircraft system” shall refer to a system, whose components include an unmanned aircraft and all equipment, network and personnel necessary to control the unmanned aircraft, while the term “unmanned aerial vehicle” shall refer to an aircraft that does not carry a human operator, is operated remotely using varying levels of automated functions, is normally recoverable, and can carry equipment necessary for receiving and transmitting video and data signals to other platforms.

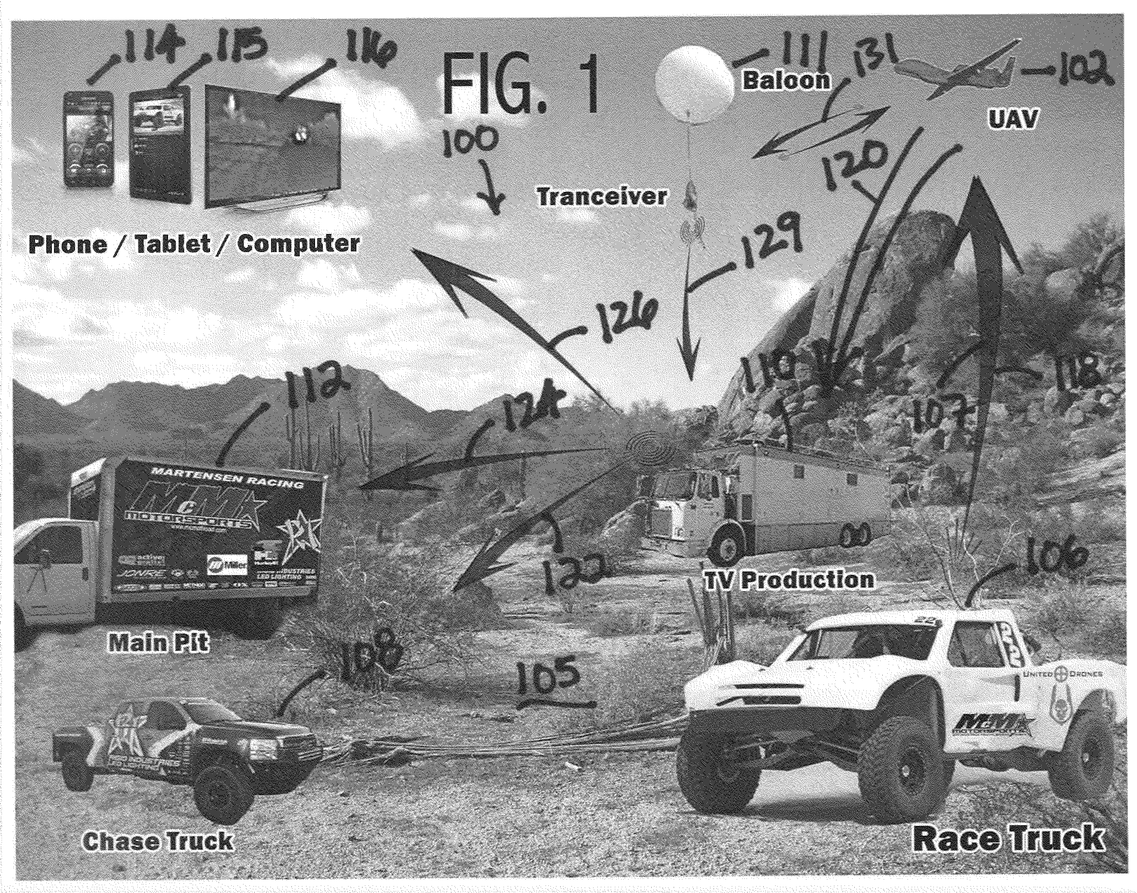

Referring to the drawings, one embodiment of an unmanned aircraft system is illustrated and generally indicated as 100 in FIGS. 1-5. In this embodiment, the unmanned aircraft system 100 may include one or more unmanned aerial vehicles 102 in aerial proximity to a course 105, such as an off-road race course, for providing a communications link between each of the unmanned aerial vehicles 102 and a production vehicle 110 may require direct line-of-sight visual communication between the unmanned aerial vehicle 102 and the production vehicle 110 to provide effective data communications. As shown in FIG. 1, the unmanned aircraft system 100 may provide a first data communications link 118 established between a race vehicle 106 and one or more unmanned aerial vehicles 102 positioned overhead in the sky along the course 105. In this manner, video and audio feeds from different camera angles within each race vehicle 106 may be communicated to the production vehicle 110 through either directly from one or more unmanned aerial vehicles 102 positioned overhead or from a tethered balloon 111 in communication with the one or more unmanned aerial vehicles 102 which then communicates that data 107 to the production vehicle 110. In addition, each unmanned aerial vehicle 102 may receive other types of data 107 from the race vehicle 106, such as, but not limited to vehicle speed, fuel consumption, motor conditions (e.g., temperature, RPM, etc), G-forces, and vehicle location.

As noted above, a second data communications link 120 may be established between each of the unmanned aerial vehicles 102 and a production vehicle 110 for providing data 107 related to each of the race vehicles 106 to the production vehicle 110. In an alternative embodiment, the unmanned aerial vehicles 102 may communicate with each other through a sixth communications link 127 such that data may be transmitted between the unmanned aerial vehicles 102. In some embodiments, each of the unmanned aerial vehicles 102 may communicate with a tethered balloon 111 that is within communications range of the unmanned aerial vehicles 102 so that the tethered balloon 111 may communicate data from the unmanned aerial vehicles 102 to the production vehicle 110 through a seventh communications link 129.

In addition to providing vehicle-related information to the production vehicle 110, each of the unmanned aerial vehicles 102 may include camera systems (not shown) that capture and communicate video, such as an aerial view of the course 105 and race vehicles 106 during the race to the production vehicle 110. In some embodiments, the production vehicle 110 functions as a mobile production center that collects data transmitted from various unmanned aerial vehicles 102 and then processes that collected data for distribution to various sources as shall be discussed in greater detail below.

In some embodiments, the production vehicle 110 may establish a third data communications link 122 between the production vehicle 110 and a chase vehicle 108 that follows the race vehicle 106 during the race. For example, it is typical in an off-road race to have a second vehicle follow or otherwise shadow the race vehicle to provide support. In some instances, such as in a Baja type race, the production vehicle 110 may also establish a fourth data communications link 124 between the production vehicle 110 and a main pit vehicle 112 for providing to the support crew the video, audio and data communications from the race vehicle 106 as well as any aerial views taken of the course 105 and the race vehicles 106 by each of the unmanned aerial vehicles 102.

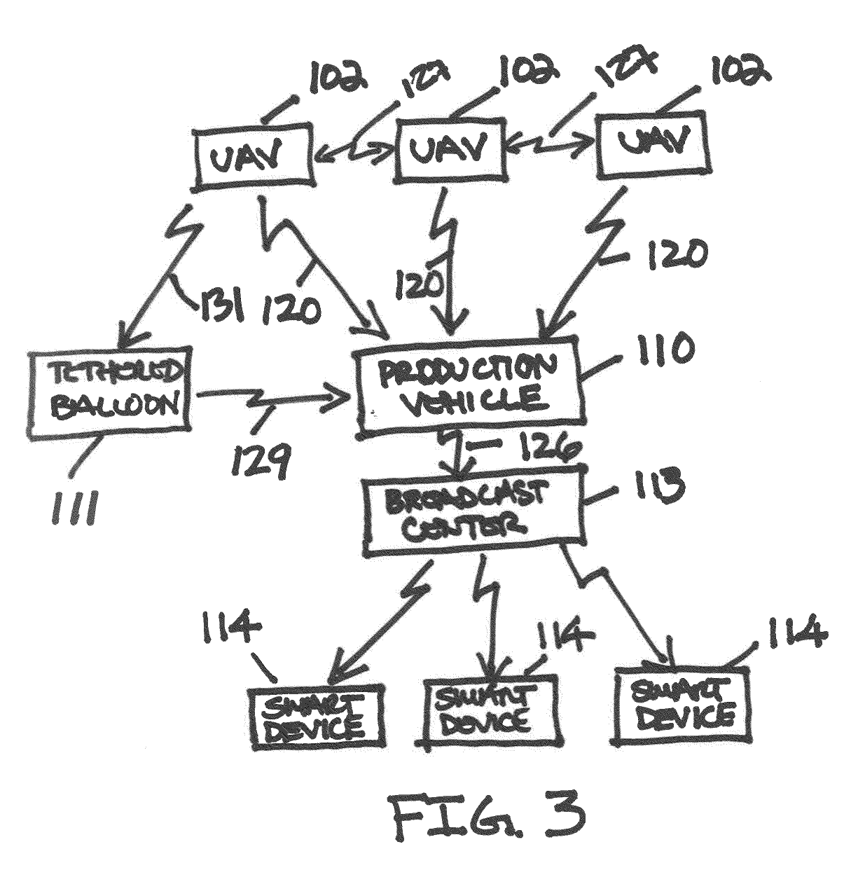

As shown in FIGS. 1 and 3, the data 107 received from one or more unmanned aerial vehicles 102 by the production vehicle 110 may be transmitted to a broadcast system 113 for eventual transmission to a smart device 114, tablet 115, other computer device 116, and/or television broadcast 176 for television 177 viewing. In some embodiments, each smart device 114, tablet 115, or other computer device 116 may employ a mobile application 130 that allows an individual, for example an individual attending the sport event, to experience various aspects of the sporting event in real time through the smart device 114, tablet 115 or other computer device 116 as shall be discussed in greater detail below. In one arrangement, the production vehicle 110 may transmit through a fifth communications link 126 to the broadcast center 113 such that real-time data processed by the production vehicle 110 is received by the broadcast center 113 for later transmission to the smart device 114, tablet 115 or other computer device 116.

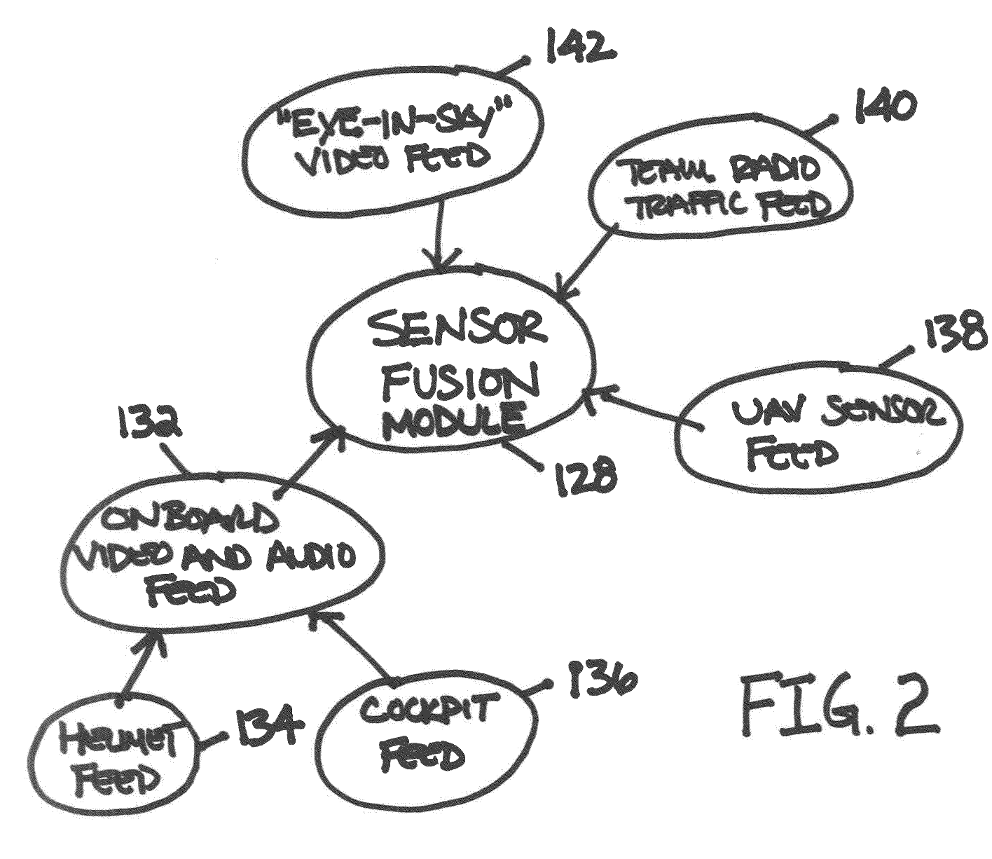

Referring to FIGS. 1 and 2, in some embodiments the unmanned aircraft system 100 may include a sensor fusion module 128 incorporated into the unmanned aerial vehicle 102 and/or the production vehicle 110 for fusing together various data feeds. For example, the sensor fusion module 128 may receive an onboard video and audio feed 132 from the race vehicle 106, or sport participant 175, such as from a helmet-based feed 134 transmitted from a camera system mounted on the helmet of each individual or from a cockpit feed 136 transmitted from a camera system mounted to one or more locations on the race vehicle 106. In addition, the sensor fusion module 128 may receive a UAV sensor feed from each unmanned aerial vehicle 102, a team radio traffic feed 140 transmitted from each race vehicle 106, chase vehicle 108, and main pit vehicle 112, an “eye-in-the-sky” video feed 142 transmitted from the camera system of each unmanned aerial vehicle 102 that provides overhead video views of the course and of particular race vehicles 106, if desired.

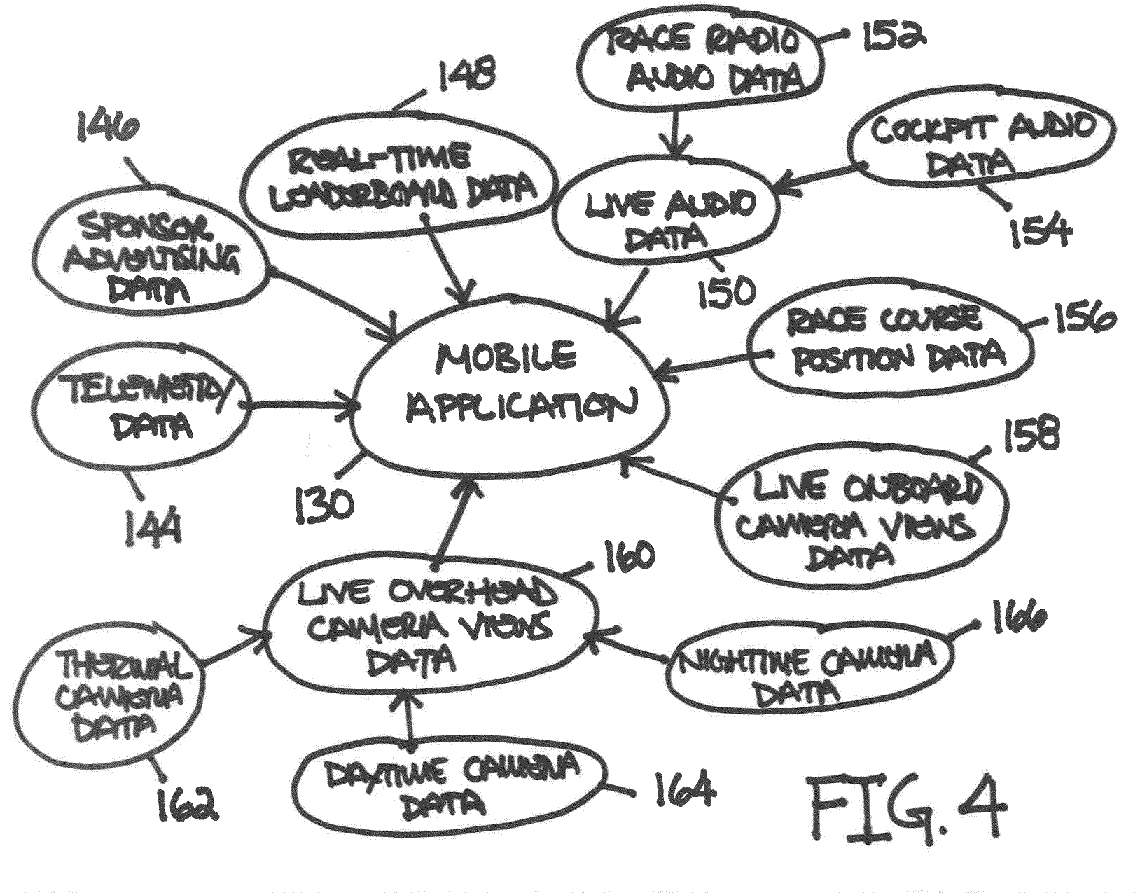

As shown in FIG. 4, the unmanned aircraft system 100 may include a mobile application 130 accessible by a microprocessor device, such as a smart device 114, tablet 115 and other computer device 116 for providing a real-time experience related to the sporting event. For example, the mobile application 130 provides video, audio and/or data feeds from multiple sources. In some embodiments, the mobile application 130 receives telemetry data 144 from each race vehicle 106 and displays to the user vehicle information derived from the telemetry data 144, such as, but not limited to accelerations (G forces) in 3 axes, temperature readings, wheel speed and suspension displacement.

In some embodiments, the mobile application 130 receives sponsor advertising data 146 for display on the smart device 114, tablet 115 and computer apparatus 116. The sponsor advertising data 146 may include banners, pop-up windows, video, audio, and/or hyper links that display and promote one or more sponsors of the sporting event and/or individual participants and their race teams. In addition, the sponsor advertising data 146 may include hyper links for each sponsor to Twitter, Facebook, and other similar social media sites. In some embodiments, sponsor advertising data 146 may be processed such that residuals may be calculated that are paid by each sponsor including percentages of such residuals for each advertisement. In addition, product approval for each sponsor may need to be obtained prior to incorporation into the mobile application 130.

In some embodiments, the mobile application 130 may receive leaderboard information data 148 related to the position of each race vehicle 106 along the course 105. In addition, the leader board information data 148 may be transmitted to each smart device 114, tablet 115 and/or computer device 116 in real time through the mobile application 130. The leader board information data 148 may include other types of information related to the relative position of each race vehicle 106, such as the relative time and distance that a particular race vehicle 106 is behind the lead race vehicle 106. The mobile application 130 may also display the leader board information data 148 in different types of illustrations showing the relative positions of each race vehicle 106 along the course 105.

In some embodiments, the mobile application 130 may receive a live audio stream data 150 from each race vehicle 106 that provides the user with real time audio between the driver and co-driver, or sport participant 175. In addition, the live audio stream data 150 may provide live audio between the race vehicle 106 and the chase vehicle 108 and/or the main pit vehicle 112. In particular, the live audio stream data 150 may include race radio audio data 152 from various other audio sources (e.g., event announcers) as well as cockpit audio data 154 directly from drivers of the race vehicle 106.

In some embodiments, the mobile application 130 may receive a racecourse position data 156 from each race vehicle 106 that provides the specific position of the race vehicle along the course 105. For example, the race course position data 156 may include simple coordinate information related to the exact position of the race vehicle 106 or sport participant 175 along the course 105.

In some embodiments, the mobile application 130 may receive real time onboard camera views data 158 that provides a live audio feed directly from each race vehicle 106 to the smart device 114, tablet 115 and computer apparatus 116. The real time onboard camera view data 158 may provide video of both interior and exterior aspects of the race vehicle 106 depending on the locations of the cameras on the race vehicle 106.

In some embodiments, the mobile application 130 may receive real time overhead camera views data 160 transmitted from each unmanned aerial vehicle 102. The real time overhead camera views data 160 may include thermal camera view data 162, which shows the heat signature of each racing vehicle 106 during the race. In addition, the real time overhead camera view data 160 may include daytime camera data 164 that shows daytime aerial camera views and nighttime camera data 166 that shows nighttime aerial camera views taken by the unmanned aerial vehicles 102.

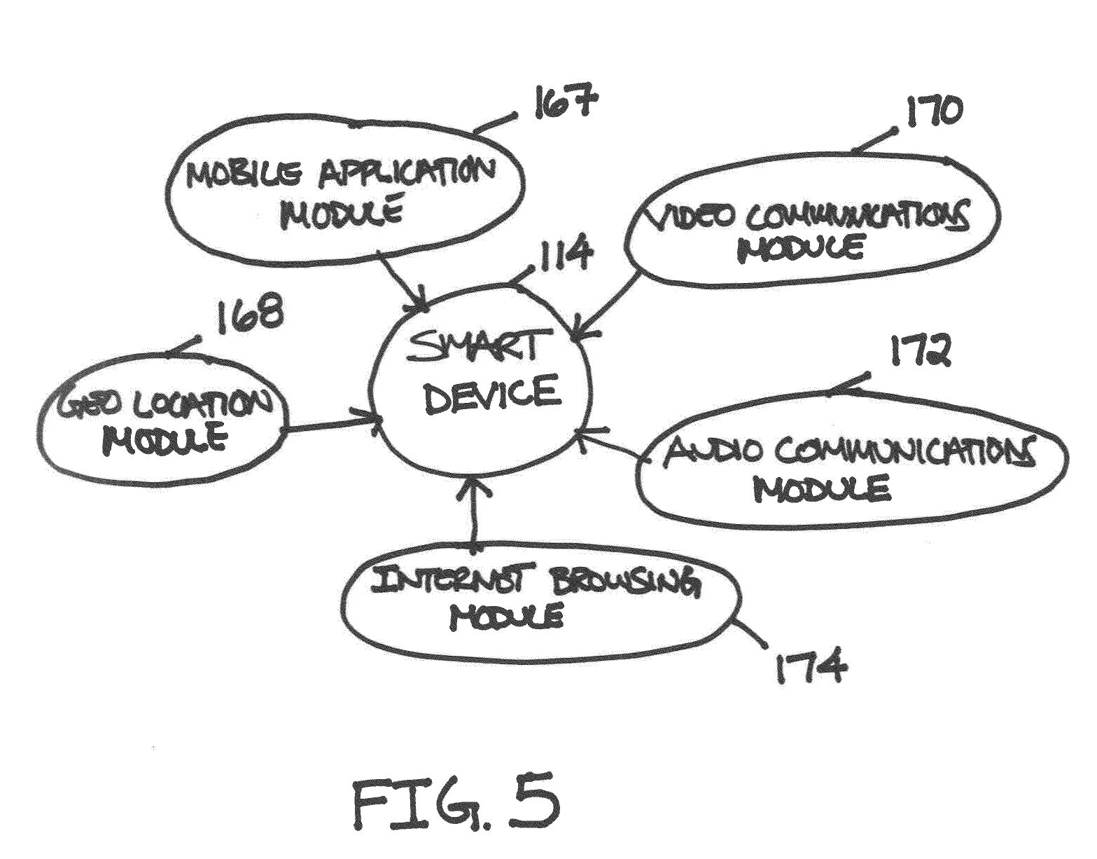

Referring to FIG. 5, the smart device 114 may include one or more modules for providing different types of functionalities related to the unmanned aircraft system 100. In some embodiments, the smart device 114 may include a mobile application module 167 that controls the operation of the mobile application 130 on the smart device 114 to perform the various functionalities of the mobile application 130 discussed above. In addition, the smart device 114 may include a geographic location module 168 for providing information related to the exact location of one or more of the race vehicles 106 and/or sport participant 175. The smart device 114 may also include a video communications module 170 and audio communications module 172 for providing real time video and audio communications from one or more of the race vehicles 106 to the smart device 114. An Internet browsing module 174 may also be included with the smart device 114 to provide an Internet browsing function. The tablet 115 and other type of computer apparatus 116 may also include the same modules described above for the smart device 114.

In some embodiments, the unmanned aircraft system 100 may be employed to cover a wide variety of sporting events in which television or smart device 114 content requires unmanned aerial vehicles 102 to facilitate data gathering, distribution, streaming /or reproduction. For example, such sporting events may include, but are not limited to, Tour De France, ironman-type events cross country skiing, downhill skiing, snowboarding, off-shore boating races, yacht racing, off-road racing, rally races, downhill bicycling, cross country racing and golf events.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. An unmanned aerial aircraft system comprising:
one or more unmanned aerial vehicles in overhead proximity to an event that covers a large geographical area, wherein the each of the one or more unmanned aerial vehicles comprises:
a camera system for providing one or more aerial camera views of the event;
a receiver for receiving event data related to the event;
a transmitter for transmitting data related to the event data and the one or more aerial camera views from the camera system;
a production vehicle for receiving the event data and the one or more aerial camera views from the one or more unmanned aerial vehicles, wherein the production vehicle generates production data based on the event data and the one or more aerial camera view, wherein the production vehicle includes a transmitter for transmitting the production data;
a microprocessor device comprising a processor for processing the production data received from the production vehicle; and
a mobile application in operative association with the microprocessor device for receiving the production data and providing video, audio, and/or data related to the event based on the production data.

2. The unmanned aircraft system of claim 1, wherein the event comprises a cross-country racecourse, a long distance racecourse with stages, a skiing racecourse, a yacht racecourse, an endurance race area, an off-road racecourse, or a golf course.

3. The unmanned aircraft system of claim 1, wherein event data comprises data related to vehicle speed, fuel consumption, motor conditions, G-forces, and vehicle location.

4. The unmanned aircraft system of claim 1, wherein the one or more unmanned aerial vehicles establishes a data communications link with one or more racing vehicles.

5. The unmanned aircraft system of claim 4, wherein the one or more racing cars includes a helmet feed for providing event data comprising live audio data and live video data to the production vehicle.

6. The unmanned aircraft system of claim 4, wherein the one or more racing cars includes a cockpit feed for providing event data to the production vehicle.

7. The unmanned aircraft system of claim 1, wherein the one or more unmanned aerial vehicles are in operative communication with one or more tethered balloons for establishing a communications link between one or more unmanned aerial vehicles and the production vehicle.

8. The unmanned aircraft system of claim 1, wherein the event data comprises at least one of telemetry data, race car position data, sponsor advertising data, real-time leaderboard data, and race course position data.

9. The unmanned aircraft system of claim 1, wherein the event data comprises thermal camera data, daytime camera data, and nighttime camera data.

10. The unmanned aircraft system of claim 1, wherein the event data comprises race audio data and cockpit audio data.

11. The unmanned aircraft system of claim 1, wherein microprocessor device comprises at least one of a smart device, a tablet, and a computer.

12. The unmanned aircraft system of claim 1, wherein the mobile application is executed on the microprocessor device for outputting video and audio data related to the production data.

13. The unmanned aircraft system of claim 1, wherein the production data is transmitted from the production vehicle to a broadcast system for transmission to the microprocessor device.

14. The unmanned aircraft system of claim 1, wherein the production data comprises leaderboard information data related to the position of a vehicle participating in the event.

15. The unmanned aircraft system of claim 1, wherein the production data comprises sponsor advertising data displayed by the mobile application on the microprocessor device, the sponsor advertising data including hyperlinks to each sponsor of the sponsor advertising data that are accessible through the mobile application.
